(19) United States
(12) Patent Application Publication
(10) Pub. No.: US 2001/0050016 A1
(43) Pub. Date: Dec. 13, 2001

(54) Method and apparatus for making a printing plate

(76) Inventors: Sadao Ohsawa, Shizuoka (JP); Yusuke Nakazawa, Shizuoka (JP); Eiichi Kato, Shizuoka (JP)

Correspondence Address: SUGHRUE, MION, ZINN, MACPEAK & SEAS, PLLC, 2100 Pennsylvania Avenue, N.W., Washington, DC, 20037, US

(21) Appl. No.: 09/814,820

(22) Filed: Mar. 23, 2001

(30) Foreign Application Priority Data
Mar. 23, 2000 (TW) P. 2000-082288

(51) Int. Cl. B41N 3/00; B41N 1/10

(52) U.S. Cl. 101/465

(57) ABSTRACT

A method of making a printing plate comprising forming an image on a surface of a first image-holding body based on image data signals by an electrostatic inkjet process comprising ejecting an oil-based ink; and contact-transferring the image formed on said first image-holding body onto a second image-holding body. Also disclosed are plate making apparatuses suitable for the method.

### FIELD OF THE INVENTION

The present invention relates to a method and an apparatus for digital plate making, and particularly to such a method and apparatus based on the use of oil-based ink and being able to make high quality plates as well as high quality printed matter.

### BACKGROUND OF THE INVENTION

In the conventional lithographic printing, an ink-receptive area and an ink-repelling area are formed on the surface of a printing plate, and a printing ink is fed on the plate so as for the ink to selectively adhere to the ink-receptive area. The adhering printing ink is then transferred to paper. Usually, the hydrophilic area and the oleophilic (ink-receptive) area are formed imagewise on the surface of a printing plate. Then, the hydrophilic area is moistened with dampening water to repel the printing ink.

Image recording on the printing plate material (plate making) is carried out, as the most popular method, by first outputting, via an analog or a digital method, an original image on a silver halide photographic film, through which a photosensitive diazo resin or a photopolymer-based layer is exposed to light, and removing such a photosensitive layer at the non-image areas with an alkaline developer.

Recently, with the advance of digital image formation technology and with the demand for a higher efficiency of printing work, a variety of proposals are being made on a system that can directly output images on printing plate using digital image information. Such methods are often called CTP (Computer-To-Plate), or DDPP (Digital Direct Printing Plate). The plate making method suited for CTP includes those based on laser exposure in light or heat mode, and some of them are being in practical use.

However, such plate making methods based on laser exposure suffer from an environmental drawback caused by the use of alkaline developer needed to remove background areas of the plate material after image exposure. This drawback is common to the light and heat modes.

Those plate making methods based on laser exposure generally require expensive and bulky apparatuses. Hence, systems based on inkjet imaging are attracting attention as they use inexpensive and compact image recording apparatuses.

JP-A-64-27953 (The term “JP-A” used herein means an “unexamined published Japanese patent application”) discloses a plate making method comprising image formation by inkjet recording using an oleophilic wax ink onto a hydrophilic plate material. However, the wax image made by this method suffers from a poor print durability because waxes are mechanically weak and poorly adhere to the hydrophilic plate surface.

### SUMMARY OF THE INVENTION

The invention that has been made to solve the foregoing problems.

Accordingly, an object of the present invention is to provide a method and apparatus for digital plate making not requiring any development processing.

Another object of the invention is to provide a method and apparatus capable of forming, via an inexpensive and simple method, a lithographic printing plate from which a large number of high quality prints can be produced.

Other objects and effects of the invention will become apparent from the following description.

The above-described objects of the present invention have been achieved by providing the following methods and apparatuses.

(1) A method of making a printing plate comprising

forming an image on a surface of a first image-holding body based on image data signals by an electrostatic inkjet process comprising ejecting an oil-based ink; and

contact-transferring the image formed on said first image-holding body onto a second image-holding body.

(2) The method according to item (1) above, wherein said oil-based ink comprises:

a non-aqueous solvent having a specific resistance not lower than 10⁹ Ωcm and a dielectric constant not higher than 3.5; and

a hydrophobic particulate resin dispersed in said solvent, the resin being solid at least at room temperature.

(3) The method according to item (1) or (2) above, further comprising setting a surface temperature of said first image-holding body to in the range of from 30 to 40° C. during said image formation.

(4) The method according to any one of items (1) to (3) above, further comprising fixing the image transferred on said second image-holding body.

(5) A plate making apparatus comprising:

an inkjet image recording unit which forms an image based on image data signals on a first image-holding body by ejecting an oil-based ink from an ink ejecting head using an electrostatic field; and

an image transfer member which transfers the image formed on said first image-holding body onto a second image-holding body by contact transfer.

(6) The plate making apparatus according to item (5) above, wherein said oil-based ink comprises:

a non-aqueous solvent having a specific resistance not lower than 109 Ωcm and a dielectric constant not higher than 3.5; and

a hydrophobic particulate resin dispersed in said solvent, the resin being solid at least at room temperature.

(7) The plate making apparatus according to item (5) or (6) above, wherein said first image-holding body is a rotary member comprising a drum or an endless belt.

(8) The plate making apparatus according to any one of items (5) to (7) above, wherein said first image-holding body is elastic.

(9) The plate making apparatus according to any one of items (5) to (8) above, further comprising a temperature control member which acts to set a surface temperature of said first image-holding body in the range from 30 to 40° C. upon said ejecting.

(10) The plate making apparatus according to any one of items (5) to (8) above, further comprising a cleaning member which cleans said first image-holding body.

(11) The plate making apparatus according to any one of items (5) to (10) above, further comprising an image fixing member which fixes the image transferred onto said second image-holding body.

(12) The plate making apparatus according to item (11) above, wherein said image fixing member includes a heating member comprising at lease one of a heat roller and a lamp selected from IR, halogen and xenon lamps.

(13) The plate making apparatus according to item (12) above, wherein said heating member is arranged and/or regulated so as to gradually elevate a temperature of said second image-holding body at said image fixing.

(14) The plate making apparatus according to any one of items (7) to (13) above, wherein said rotary first image-holding body is rotatable to carry out main scanning upon said image recording onto said first image-holding body.

(15) The plate making apparatus according to item (14) above, wherein said ink ejecting head comprises a single-channel or multi-channel head movable in a direction parallel to an axis of said rotary first image-holding body to carry out sub-scanning upon said image recording.

(16) The plate making apparatus according to item (14) above, wherein said ink ejecting head comprises a full-line head having a width substantially equal to that of said first image-holding body.

(17) The plate making apparatus according to any one of items (5) to (16) above, wherein said inkjet recording unit has an ink feeding member which feeds said oil-based ink to said ink ejecting head.

(18) The plate making apparatus according to item (17) above, wherein said inkjet recording unit has an ink recovering member which recovers said oil-based ink from said ejecting head to circulate said ink.

(19) The plate making apparatus according to any one of items (5) to (18) above, wherein said inkjet recording unit has an ink tank and an agitating member which agitates the oil-based ink in said ink tank.

(20) The plate making apparatus according to any one of items (5) to (19) above, wherein said inkjet recording unit has an ink temperature control member which controls a temperature of the oil-based ink at least one of inside an ink tank and inside an ink flowing path.

(21) The plate making apparatus according to any one of items (5) to (20) above, wherein said inkjet recording unit has an ink concentration control member.

(22) The plate making apparatus according to any one of items (5) to (21) above, further comprising a cleaning member for said ink ejecting head.

### BRIEF DESCRIPTION OF THE DRAWINGS

FIGS. 1(a) and 1(b) illustrate the construction of a plate making apparatus used for the invention.

FIG. 2 illustrates the construction of a fixing unit used for the invention.

FIG. 3 illustrates the construction of the image recording unit of a plate making apparatus used for the invention.

FIG. 4 illustrates the construction of an ink ejecting head equipped in an inkjet recording unit used for the invention.

FIG. 5 illustrates a cross-sectional view around the ejecting point of the head shown in FIG. 4.

FIG. 6 illustrates a cross-sectional view around the ejecting point of another head installed in an inkjet recording unit used for the invention.

FIG. 7 is a front-end view schematically showing the neighborhood of the ejecting point of the head shown in FIG. 6.

FIG. 8 illustrates the significant part of another ejecting head equipped in an inkjet recording unit used for the invention.

FIG. 9 schematically illustrates a bird-eye view of the ejecting head shown in FIG. 8 from which the regulating plates have been removed.

FIG. 10 schematically illustrates the significant part of another ejecting head installed in an inkjet recording unit used for the invention.

### DETAILED DESCRIPTION OF THE INVENTION

The invention is characterized by first forming an image on a first image-holding body by an inkjet recording process using an oil-based ink, and then carrying out contact transfer of said image onto a second image-holding body. As will be described later, the first image-holding body comprises, for example, a drum that has been machined and arranged with a very high preciseness and possesses a smooth surface. Thus, the distance between the surface of said first image-holding body and the head can be adjusted very precisely, achieving a high positional accuracy of the ejected ink on the surface consistently. Such a high positional accuracy leads to highly precise image formation. By carrying out contact transfer of the image from the first to the second image-holding body, the contact pressure as well as the contact temperature can be optimally controlled during transfer to achieve a high level of image-holding strength on the second image-holding body. And, by fixing the transferred image, the image-holding strength is further enhanced. Owing to these procedures, a large number of high quality prints can be produced consistently.

In the invention, the dimension of the end of an ejecting electrode or the conditions of electrostatic field formation determines the size of ink droplet. Thus, by using a small ejecting electrode or by optimizing the electrostatic field forming conditions, one can realize minute ink droplets without reducing the ink ejecting nozzle diameter or slit width. Accordingly, a fine control for image recording is possible without accompanying the drawback of nozzle choking with ink. Based on such an inkjet recording method, the invention provides a plate making method and apparatus that can produce printing plates from which crisp and sharp prints can be made in a large number.

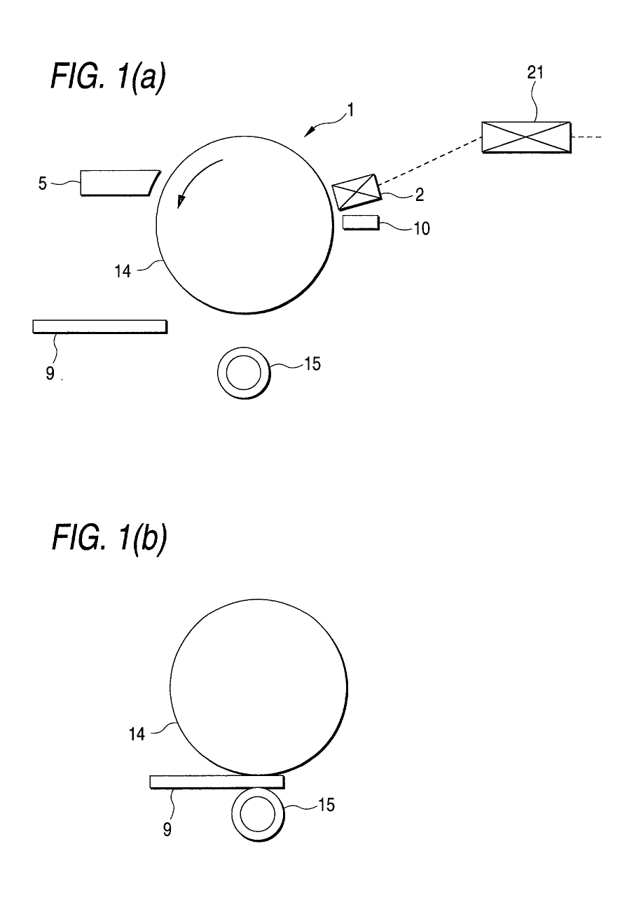

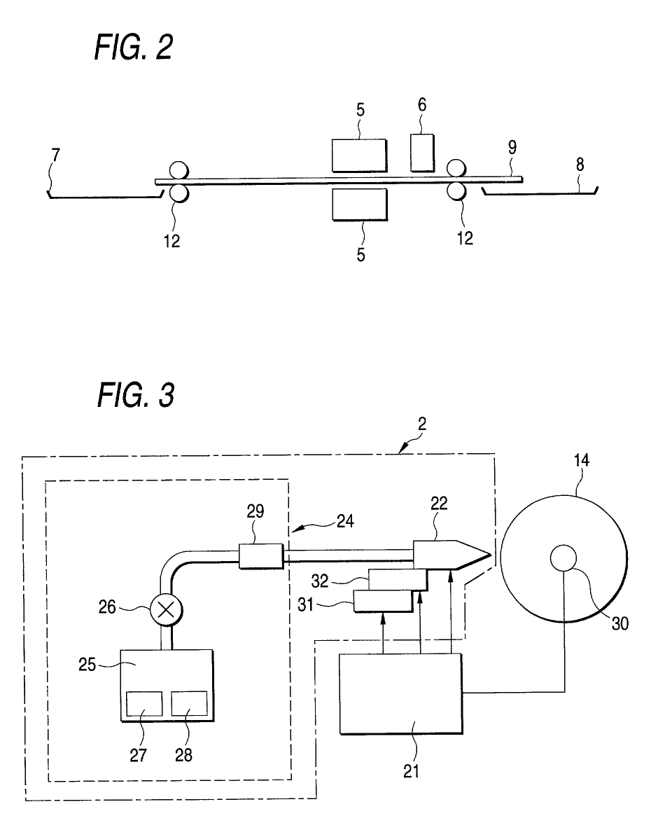

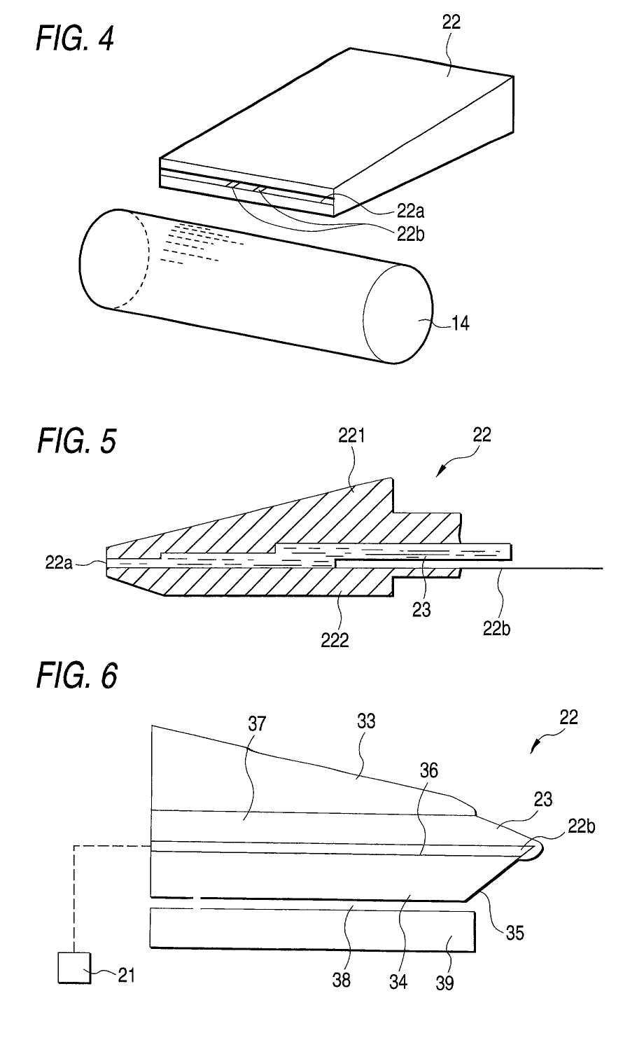

In the following, some practical embodiments for carrying out the invention will be described in detail. FIGS. 1 and 2 show the construction of a plate making apparatus in conformity with the invention. FIG. 3 schematically shows the image recording unit of the apparatus including a control unit, an ink feeding member and a head distancing/approximating mechanism. FIG. 4 to FIG. 10 are given to describe the inkjet recording unit installed in the plate making apparatus shown in FIG. 1 and FIG. 2.

The plate making procedures according to the invention will be described with reference to FIG. 1. The first image-holding body comprises a rotary body such as drum or endless belt. In the following description, the first image-holding body is assumed to be a drum. However, the scope of the invention is not limited to the following embodiments at all.

Drum 14 is usually made of metal such as aluminum, stainless steel or iron, plastic, or glass, and, to secure an intimate contact with a second image-holding body to be described later, is preferably provided with an elastic layer comprising styrene/butadiene rubber, isoprene rubber, silicone rubber, nitrile rubber, butyl rubber or fluorocarbon rubber. The elastic layer should be not thinner than 0.2 mm, and preferably 0.7 mm thick or more. A preferable range is roughly from 1 mm to 15 mm. Further, the elastic layer may be provided with a surface layer comprising one or more thermoplastic resins such as polyethylene, polypropylene, poly (ethylene terephthalate), polystyrene, polyurethane, polyamide, polymers or copolymers comprising vinyl chloride or vinyl ethylene-acetate. To control the ease of image transfer from the surface of the first image-holding body, fluorocarbon resins or silicone resins can be preferably added in the form of polymer and/or powder to the surface layer. The surface layer can be formed by dispersing or dissolving all its ingredients including suitable additives in a solvent and by coating the resulting mixture on the elastic layer of drum 14. The surface layer should have a thickness of 10 μm to 1 mm.

For electrostatic ink ejection, drum 14 is desirably kept at the ground potential as it acts as the counter electrode to the ejecting electrode. When the elastic layer and the surface layer are thick showing a undesirably high resistance, an electro-conductive layer may be provided in drum 14. In this case, the electro-conductive layer is grounded.

Plate making apparatus 1 has inkjet recording unit 2, which ejects oil-based ink to form on the surface of drum 14 an oil-based ink image corresponding to image data sent from image data processing and control unit 21 to be described later. In such image formation, it is desirable to maintain the surface layer at a temperature in the range of 30 to 40° C. to guarantee a firm adhesion of the oil-based ink to the surface layer. Printer 1 has furthermore dust-removing member 10 that removes dust present on the surface layer of drum 14 prior to or during recording. With such means, a high quality recording can be performed by preventing undesirable ink deposition made via the surface of dust lying between the head and the drum during recording. Dust can be removed by any method known in the art including non-contact ones such as air suction, blow-off or electrostatic removing, and contact ones using a brush or a roller. Among them, the most preferable method is air suction or air blow These methods can be applied separately or in combination.

The image formed on the surface layer of drum 14 is then transferred onto plate 9 which has been referred to as second image-holding body. Image transfer is performed by inserting plate 9 between drum 14 and heat roller 15 as image transfer member arranged against the drum. During image transfer, heat roller 15 is heated to a pre-determined temperature range (usually 40 to 120° C.). Heat roller 15 stays in a retreated position during image formation on drum 14 (FIG. 1(a)), and then, for image transfer, moves from that position to get in pressed contact with the drum at a pre-determined pressure (FIG. 1(b)). During image formation, the surface of drum 14 is heated to about 30 to 40° C., thus, the transfer takes place under the application of heat to the drum 14 and plate 9 contacted with each other. With the help of the contact pressure between drum 14 and plate 9, the transferred image is held at the transferred place with certainty. Further, by the fixing operation to be explained soon (FIG. 2), the image retention strength exerted by plate 9 is enhanced.

FIG. 2 shows an example of the unit for fixing images after the transfer onto plate 9. Two pairs of capstan rollers 12 conveys plate 9 to fixing member 5 where the oil-based ink image is fixed. Desensitizing unit 6 may be placed to enhance the hydrophilic nature of the surface of plate 9. It is also preferable to install automatic plate loader 7 that feeds plates automatically, and plate unloader 9 that unloads plates after fixing and/or desensitization. By using those means, the plate handling operations become easy and the time required for plate preparation is shortened to further effect the advantageous features of the invention.

Some transport guides not shown in the figure may be used for the transport of plate 9 to prevent the leading or trailing edge of the plate from flapping that may lead to accidental damaging of fixing unit 5.

Alternatively, accidental contact of plate 9 from with fixing unit 5 is prevented by restricting the plate floating only near the fixing point of fixing unit 5 with certain means operated during fixing operation. As a practical example, plate-suppressing rollers may be arranged at the upstream and downstream sides near the fixing unit.

Image data processing and control unit 21 receives image data from image scanners, magnetic disk devices or image data transmission devices, and, when needed, separates color information, and divides each color-separated data into suitable pixels and gradation levels. Further, in order to output oil-based, halftone inkjet images by using ink ejecting head 22 (See FIG. 3. A detailed description will be given later.) involved in inkjet recording unit 2, area coverage values are calculated, too. Image data processing and control unit 21 also controls the movement of inkjet head 22, the ejection timing of oil-based ink, and, when required, the rotary timing of drum 14.

Those calculated data sent to image data processing and control unit 21 are once stored in a buffer memory. Image data processing and control unit 21 rotates drum 14, and moves inkjet head 22 using head distancing/approximating unit 31 to a position close to drum 14. The gap between the head 22 and the surface of drum 14 is kept at a pre-determined value during recording by mechanical control with a spacing roller, or by controlling the motion of the head by the head distancing/approximating unit driven by the signal from an optical gap detector. Owing to such a gap control, the recorded dot size would not fluctuate even when vibrations are applied to the plate making apparatus.

Ejecting head 22, which may be of single-channel type, multi-channel type, or of full line type, performs main scanning by the rotation of drum 14. In cases where the head is of multi-channel type or has a full line width, both having plural ejecting points, those points are arranged along the axial direction of drum 14. In the case of a single-channel or a multi-channel head, head 22 is moved along the drum axis after each drum rotation by image data processing and control unit 21, and an oil-based ink is ejected onto the surface of drum 14 so as to achieve the area coverage value at every calculated position. In this manner, a halftone image comprising the oil-based inkjet ink and reproducing the density distribution of the original is formed on drum 14. Such procedures continue until an ink image corresponding to a single color for the original completes. On the other hand, in the case of a full line width head, every rotation of drum 14 completes the formation of a single color image for the original on drum 14. As the drum rotates to carry out main scanning, the positional accuracy along the main scanning direction becomes high with a very high recording speed.

Next, heat roller 15 is moved to get in pressed contact with drum 14, and plate 9 is driven between heat roller 15 and drum 14 to cause the oil-based ink image formed on drum 14 to transfer onto plate 9. Fixing unit 5 acts to enhance the mechanical strength of the transferred oil-based ink image. Image fixing can be performed by various methods known in the art by means of heat or solvent. For heat fixing, irradiation with an infrared lamp, a halogen lamp or a xenon flash lamp, heated air fixing or heat roll fixing can be generally adopted. Flash fixing with a xenon lamp, well known as a fixing method for electrophotographic toner, has an advantage of a very short fixing time. When the base of the plate is made of paper, a rapid temperature rise promotes an abrupt moisture vaporization to yield blisters in the plate surface. To avert blister formation, the temperature of such a paper-based plate should be preferably raised gradually by using a plurality of fixing members and supplying varying electric power to each means and/or changing the distance from each means to plate 9.

In solvent fixing, a solvent such as methanol or ethyl acetate that can dissolve the resinous ingredient in the ink is brought into contact with the plate in the form of spray mist or vapor, followed by the recovery of the excess.

The plate thus prepared is subjected to conventional lithographic printing; i.e., the plate bearing the oil-based ink image is loaded on a press, supplied with a printing ink and dampening water to give rise to a process ink image, which is first transferred onto a blanket cylinder rotating with a plate cylinder, and then further from the blanket cylinder to a sheet of printing paper passing between the blanket cylinder and an impression cylinder. In this way, printing of one color finishes. With the end of printing, the plate is unloaded from the plate cylinder, and the blanket of the blanket cylinder is washed with a blanket-washing device for next press operation.

Inkjet recording unit 2 will be described in detail.

As is illustrated in FIG. 3, inkjet recording unit 2 used for plate making comprises ink ejecting head 22 and ink feeding unit 24. Ink feeding unit 24 comprises ink tank 25, ink feeder 26 and ink concentration controller 29. Inside ink tank 25 is equipped with an agitating member 27 and ink temperature control member 28. The ink may be circulated in ejecting head 22, in which case ink-feeding unit 24 has the functions of ink recovery and circulation, too. Agitating member 27 acts to prevent the precipitation or aggregation of the solid ingredients in the ink, thus reducing the frequency of cleaning ink tank 25. Practical examples of the agitating member include a rotating blade, an ultrasonic oscillator and a circulation pump, which can be used individually or in combination. Ink temperature control member 28 is needed to secure the consistency of the recorded image quality by keeping the physical properties of the ink substantially constant and thus by suppressing dot size fluctuation. Temperature control can be carried out by any known method in the art, for example, by providing ink tank 25 with a heat-generating or heat-absorbing element such as heater or Peltier element together with agitating member 27 that averages the temperature distribution inside the tank and a temperature sensor such as thermostat. The temperature of the ink kept in tank 25 should preferably be held between 15° C. and 60° C., and more preferably between 20° C. and 50° C. The agitating member for temperature distribution averaging may also be used to prevent the precipitation or aggregation of the solid ingredients of the ink.

Moreover, to output high quality images, the present plate making apparatus should preferably be provided with ink concentration control member 29. When the solid content of the ink falls, the resulting image tends to spread laterally on the plate or becomes unclear while ink concentration increase causes dot size to fluctuate. Such drawbacks can be effectively prevented by control member 29. The concentration of ink is monitored optically, by measuring its physical properties such as electro-conductivity or viscosity, or by the integral number of recorded plates. In the case where physical property measurements are made, an optical detector, a conductivity or viscosity sensor is installed in tank 25 and/or along the ink flow path individually or in combination, and the output signals from such measuring devices are used for the replenishment of an undiluted ink or an ink diluent from a corresponding reservoir, (both not shown in the figure) to the ink tank. In the management based on plate number, a similar replenishment is made according to the integrated number of recorded plates or the frequency of recording.

In addition to the processing of input image data or the motion control of the head using head distancing/approximating unit 31 or head sub-scanning means 32, image data processing and control unit 21 shifts the head according to the timing pulse from encoder 30 provided on drum 14 or on the capstan rollers in which case the positional accuracy is improved.

Next, ink-ejecting head 22 is described in detail with reference to FIG. 4 to FIG. 10, not to limit the scope of the invention.

FIG. 4 and FIG. 5 depicts an example of ink-ejecting head 22 equipped in the present inkjet recording unit. Head 22 has ink-ejecting slit 22a formed with upper unit 221 and lower unit 222, both made of an insulator; inside the slit is ejecting electrode 22b, and the interior space of the head is filled with ink 23 fed by the ink feeder. Insulators used for the upper and lower units include plastic, glass or ceramic. Ejecting electrode 22b can be formed via various methods well known in the art; typically, on lower unit 222 comprising an insulator is formed a conductive layer consisting of aluminum, nickel, chromium, gold or platinum by vacuum deposition, spattering or electroless plating, then on the layer a photo-resist coating is made, which is exposed through a mask having a pre-determined electrode pattern followed by development to give a photo-resist pattern of ejecting electrode 22b, and finally etching or mechanical removal is performed. Each of the known methods may be adopted solely or in combination with each other

To ejecting electrode 22b of inkjet head 22 is applied a potential modulated by the digital signal representing an image pattern. As is shown in FIG. 4, drum 14 is arranged so as to face and act as the counter electrode to 22b. By applying a potential, an electric circuit is formed with electrode 22b and drum 14, thus causing oil-based ink 23 to eject from ejecting slit 22b of head 22 toward the surface of drum 14, thus giving rise to an image thereon.

The width of electrode 22b should be as small as possible for high quality image formation. A preferable range, which depends on applied voltage and/or ink properties, is usually from 5 to 100 μm.

A practical example for the combination of the parameters involved is as follows; with the tip of ejecting electrode 22b of 20 μm width, the distance between ejecting electrode 22b and drum 14 as a counter electrode being 1.0 mm, and by applying 3 kV between the two electrode for 1 msec, a 40 μm diameter dot can be formed on drum 14.

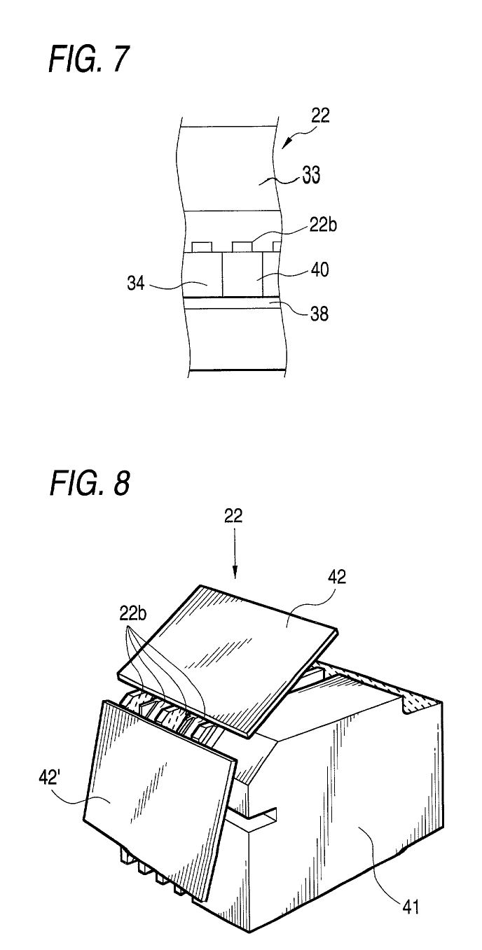

Each of FIGS. 6 and 7 schematically depicts the cross-sectional or the front view of another ejecting head, respectively. Ejecting head 22 has a first insulating wall 33 with a tapered cross-section. A second insulating wall 34 faces this first wall 33 with an intervening space, and the forefront end of 34 is inclined. Those walls are made of, for example, plastic, glass or ceramic. On the upper plane 36 that forms an acute angle with the inclined forefront end 35 of insulating wall 34, plural ejecting electrodes 22b are provided as electrostatic field forming means at the ejecting points. The forefront end of each electrode 22b extends to the end of the upper plane 36, and protrudes beyond the end of the first insulating wall 33, thus forming an ink ejecting point. The space between first and second insulating walls 33 and 34 makes ink flow path 37 through which the ink is fed to the ejecting point. On the second insulating wall 34 is formed an ink recovering path 38. The ejecting electrodes 22b are formed by any conventional method well known in the art using a conductive material such as aluminum, nickel, chromium gold or platinum. Each electrode 22b is electrically insulated from each other.

The length by which the end of ejecting electrode 22b protrudes beyond the end of wall 33 should not exceed 2 mm. When this length is larger than the cited limit, the ink meniscus will not reach the end of the ejecting electrode, in which case ink ejection becomes difficult or the recording frequency drops. The space between walls 33 and 34 should be 0.1 to 3 mm. Narrower spaces than this range make ink feed difficult, and also cause the drop of recording frequency. On the other hand, broader spaces make the ink meniscus unstable, causing ink ejection inconsistent.

Image data processing and control unit 21 controls the potential of ejecting electrode 22b according to image data, and electrode 22b ejects ink onto the drum (not shown in the figure) arranged to face the ejecting point of the electrode. The left-side end of ink flow path 37 is connected to the feeding member of an ink feeder not shown in the figure. Below the second insulating wall 34, backing 39 is provided parallel to 34 with an intervening spacing. The spacing in-between forms ink-recovering path 38. This spacing should preferably be not narrower than 0.1 mm from the viewpoint of the difficulty of ink recovering as well as the prevention of ink leakage. Ink recovering path is connected to an ink recovering member of an ink feeder not shown in the figure.

In the case where a uniform ink flow on the ejecting point is needed, thin grooves 40 may be formed between the ejecting point and the ink-recovering path. FIG. 7 schematically illustrates the front view of the ink ejecting point, in which the inclined front end of insulating wall 34 has a plurality of thin, linear grooves 40 running from the boundary with electrode 22b to ink recovering path 38. Such grooves attract a certain amount of ink in the neighborhood of the aperture of electrode 22b by capillary force towards ink-recovering path 38. Owing to this discharging action of the grooves, an ink layer of a constant and uniform thickness can be formed near the end of the ejecting electrode. The shape and size of grooves 40, which are designed so as to exert a sufficient capillary force, should preferably be 10 to 200 μm wide and 10 to 300 μm deep. It should be noted that grooves 40 must be provided over the entire width of the ejecting head with a purpose of forming a uniform ink flow.

The width of electrode 22b should be as small as possible for high quality image formation. A preferable range, which depends on applied voltage and/or ink properties, is usually from 5 to 100 μm.

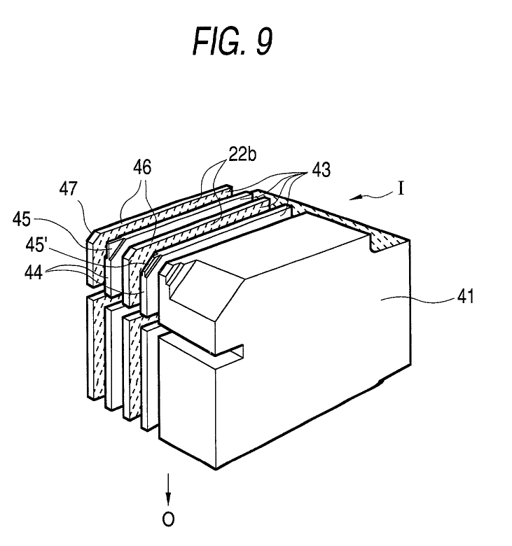

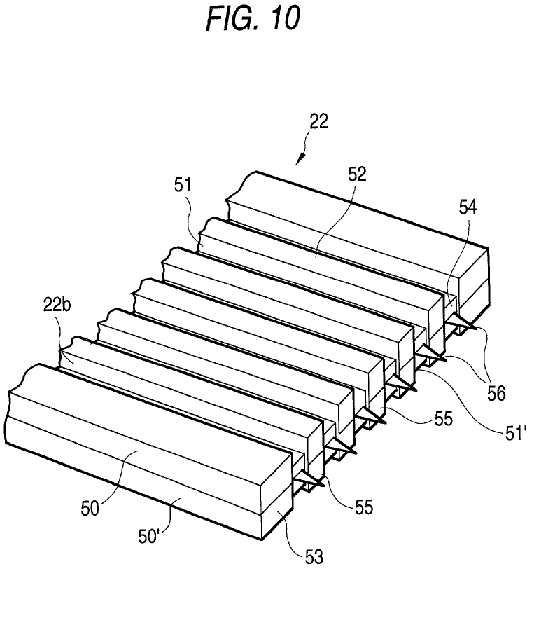

Some other examples of the ejecting head used in the d~ invention are illustrated in FIG. 8 and FIG. 9. FIG. 8 depicts schematically a part of such a head. Head 22 comprises head body 41 made of an insulating material such as plastic, ceramic or glass and meniscus regulating plates 42 and 42′. A voltage is applied to ejecting electrode 22b to form an electrostatic field at the ejecting point. A more detailed description of the head body will be made with reference to FIG. 9 in which meniscus regulating plates 42 and 42′ are removed.

Perpendicularly to the edge of head body 41, plural ink grooves 43 are provided for ink circulation. The shape and size of grooves 43, which are designed so as to achieve a uniform ink flow by capillary force, should preferably be 10 to 200 μm wide and 10 to 300 μm deep. Inside grooves 43 are provided ejecting electrodes 22b. These electrodes can be formed on head body 40 made of an insulating material with the use of an electro-conductive material such as aluminum, nickel, chromium, gold or platinum to cover the surface of grooves 43 entirely or partly. The concrete method of electrode formation has been already given in the description of FIG. 4 and FIG. 5. Each ejecting electrode is isolated from each other. Contiguous two grooves form a single cell. At the tip of dividing wall 44 located at the center of the cell are provided ejecting points 45 and 45′. At these ejecting points 45 and 45′, the dividing wall is fabricated thinner than the remaining area of 44, thus forming sharp edges. Such a structure of the head body can be made by any method known in the art including mechanical processing, etching or molding a block of the insulating material. The thickness of the dividing wall should preferably be 5-100 μm, and the diameter of curvature at the sharpened edge should preferably be in the range of 5 to 50 μm. The corner of the point may be slightly beveled as 45′ shown in the figure. The figure depicts only two cells, and the cells are separated with dividing wall 46, and its tip 47 is beveled in such a manner that tip 47 stands back relative to ejecting points 45 and 45′. An ink feeding member of an ink feeder not shown in the figure supplies ink to the ejecting point via the ink grooves from the direction designated by I. Further, excessive ink is recovered by an ink recovering member not shown in the figure to the direction designated by O. Thus, the ejecting point is always fed with fresh ink. By using such a configuration under such an operating condition described above, ink is ejected from the ejecting head to a plate material held on a drum (not shown in the figure) by the application of signal voltage modulated by image data to the ejecting electrode.

Still another example of the ejecting head is described with the help of FIG. 10. Ejecting head 22 has supporting members 50 and 50′ made of substantially rectangular boards of plastic, glass or ceramic with a 1 to 10 mm thickness. On one side of each board are formed plural grooves 51 and 51′ parallel to each other. The spacing of the grooves is determined by the image resolution to be recorded. Each groove 51 or 51′ should preferably be 10 to 200 μm wide and 10 to 300 μm deep. In each groove, ejecting electrode 22b is formed that covers the surface of the groove entirely or partly. By forming plural grooves 51 and 51′ on one surface of supporting members 50 and 50′, plural dividing walls 52 result between each groove 51. Supporting members 50 and 50′ are bonded together at the surfaces opposite to the ones on which the grooves were formed. As a result, on its outer surface, ejecting head 22 has grooves 51 and 51′ through which ink flows. Upper groove 51 is connected to lower groove 51′ via rectangular end 54 of ejecting head 33, and rectangular end 54 stands back relative to upper end 53 of ejecting head 22 by a pre-determined distance of about 50-500 μm. In other words, on both sides of each rectangular end 54, there is provided upper end 55 of each dividing wall 52 of each supporting members 50 and 50′. And, from each rectangular end 54, guiding part 56 made of an insulator described previously protrudes to form an ejecting point.

In order to circulate ink to ejecting head 22 thus constructed, ink is fed to rectangular end 54 through each groove 51 provided on the outer surface of supporting member 50, and driven out via each lower groove 51′ formed in the opposite surface of lower supporting member 50′. To facilitate a smooth ink flow, ejecting head 22 is slanted by a pre-determined angle so that the feeding side (supporting member 50) be located upward relative to the discharge side (supporting member 50′). When ink is circulated in such an arrangement, ink passing each rectangular end 54 wets each projection 56 and forms an ink meniscus near rectangular end 54 and projection 56. Facing to the menisci thus formed independently on all projections, a drum is arranged (not shown in the figure). An electric field is formed between the drum and ejecting electrode 22b modulated by image data to cause the ink to eject for image formation. Alternatively, ink can be compulsorily circulated by forming a cover sealing the grooves formed on the outer surfaces of supporting members 50 and 50′, thus forming an ink flow pipe. In this construction, ejecting head 22 need not be inclined.

Each ejecting head 22 depicted in FIG. 4 to FIG. 10 can be provided with maintenance device such as cleaning member. As an example, when the recording unit is suspended for a prolonged period or when some problems take place as for the quality of recorded images, the tip of the ejecting head is wiped with a soft brush or a piece of soft cloth, the ink solvent is fed to or circulated in the head together with or without suction of the head. These countermeasures may be used individually or in combination to keep the recording characteristics of the head in a desirable condition. To prevent ink solidification, head cooling is effective as it suppresses the vaporization of the ink solvent. When the head is heavily contaminated, ink is compulsorily sucked from the ejecting end, or an air pulse or an ink solvent is injected from the head or the ink flow path. Alternatively, it is also effective to apply ultrasonic wave to the head immersed in the ink solvent. Those methods can be adopted individually or in combination.

Another cleaning member may be equipped to clean drum 14. As the oil-based ink image formed on the drum is transferred substantially perfectly onto the plate, drum cleaning can be performed just by just activating the dust removing member.

Next, plate materials as the second image-holding body used in the invention will be described in detail.

Metal plates comprising aluminum or chromium-plated Steel are preferred. Particularly, aluminum plates having a highly water-receptive and wear-resistant surface formed by graining and/or anodic oxidation are preferred. More economical materials include those comprising a superficial image-receiving layer provided on a water-resistant substrate including water-resistant paper, plastic films or paper/plastic film laminates. A preferable thickness range for such materials is 100 to 300 μm whereas the image-receiving layer preferably has a thickness of 5 to 30 μm.

Preferable examples of such image-receiving layers include hydrophilic layers comprising inorganic pigments and a binder, or those that can be converted hydrophilic via a suitable desensitizing treatment.

Inorganic pigments used in the hydrophilic image-receiving layer include clay, silica, calcium carbonate, zinc oxide, aluminum oxide and barium sulfate. Suitable binder materials include hydrophilic compounds such as poly (vinyl alcohol), starch, carboxymethyl cellulose, hydroxyethyl cellulose, casein, gelatin, polyacrylic acid salts, poly (vinylpyrolidone) and methyl ether-maleic anhydride copolymer. In the case where certain levels of water resistance are needed, cross-linking agents such as melamine-formaldehyde resin or urea-formaldehyde resin may be incorporated.

On the other hand, layers comprising zinc oxide dispersed in a hydrophobic binder represent image receiving ones used with a desensitizing treatment.

Any type of zinc oxide that is commercially available as zinc white, wet process zinc white or active zinc white can be used in the invention. As for zinc oxide, reference is made to p. 319 of “Shinpan Ganryo Binran” (Pigment Handbook, a New Edition) edited by Pigment Technology Association of Japan and published by Seibundo Publishing Co. in 1968.

Zinc oxide is classified according to its raw material and manufacturing process; dry procedures include French (indirect) and American (direct) processes, and wet processes are also employed. Representative manufacturers include, for example, Seido Chemical Co., Sakai Chemical Co., Hakusui Chemical Co., Honjo Chemical Co., Toho Zinc Co., and Mitsui Metal Industries Co.

Resinous materials used for the binder of the zinc oxide layer include styrene copolymers, methacrylate copolymers, acrylate copolymers, vinyl acetate copolymers, poly (vinyl butyral), alkyd resins, epoxy resins, epoxy ester resins, polyester resins and polyurethane resins. Each of those may be used alone or in combination.

The content of the resin binder in the image-receiving layer preferably lies between 9/91 and 20/80 in terms of binder/zinc oxide weight % ratio.

Such a zinc oxide layer is desensitized by the treatment with a desensitizing solution well known in the art. Suitable desensitizing solutions include cyanide-containing ones comprising ferrocyanide or ferricyanide salts, cyanide-free ones comprising amine cobalt complexes, phytic acid and its derivatives or guanidine derivatives, those comprising inorganic or organic acids capable of forming a chelate with zinc ion, or those containing water-soluble polymers.

Cyanide-containing solutions are disclosed in, for example, JP-B-44-9045 (The term “JP-B” used herein means an “examined Japanese patent publication”), JP-B-46-39403, JP-A-52-76101, JP-A-57-107889 and JP-A-54-117201.

The back surface opposite to the image-receiving layer of the plate material should have a Beck smoothness of 150 to 700 (sec/10 mL). With such a back surface, the plate will not slip or shift during image transfer or on the plate cylinder, thus enabling a highly precise image transfer.

Beck smoothness can be measured with a Beck smoothness tester; a test piece is pressed against a circular hole provided at the center of a glass plate having an extremely smooth surface at a pre-determined pressure (1 kgf/cm² or 9.8 N/cm²), and the time required for a fixed volume (10 mL) of air to leak between the glass plate and the test piece under a reduced pressure is measured.

The oil-based inkjet ink used in the invention will be explained in the following.

The oil-based ink used in the invention comprises a non-aqueous solvent that has a specific resistance not lower than 10Ωcm and a dielectric constant not exceeding 3.5, and a hydrophobic particulate resin dispersed in the solvent, the resin being solid at least at room temperature.

Such non-aqueous solvents with a specific resistance not lower than 10⁹ Ωcm and a dielectric constant not exceeding 3.5 and preferably used in the invention include straight or branched chain aliphatic hydrocarbons, alicyclic hydrocarbons, aromatic hydrocarbons, and halogen substituted derivatives of these hydrocarbons. Some examples are hexane, heptane, octane, isooctane, decane, isodecane, decaline, nonane, dodecane, indodecane, cyclohexane, cyclooctane, cyclodecane, benzene, toluene, xylene, mesitylene, Isopar C, Isopar E, Isopar G, Isopar H, Isopar L (Isopar is a trade name of EXXON Co.), Shellsol 70, Shellsol 71 (Shellsol is a trade name of Shell Oil Co.), Amsco OMS, Amsco 460 solvent (Amsco is a trade name of Spirits Co.) and silicone oil. They are used individually or as mixtures. The upper limit of the specific resistance of these non-aqueous solvents is about 10¹⁶ Ωcm, and the lower limit of the dielectric constants is about 1.9.

When the resistance of the non-aqueous solvent used in the invention is below the lower limit of the preferable range mentioned above, the resinous particles will not be concentrated, resulting in output images with insufficient run lengths while, when the dielectric constant exceeds the upper limit of the preferable range mentioned above, a too much relaxation of electric field takes place due to the polarization of the solvent, deteriorating the consistency of ink ejection.

The particulate resin (P) dispersed in the non-aqueous solvent described above should preferably be solid at temperatures not exceeding 35° C., and have a sufficient affinity to non-aqueous solvents. Moreover, those having a glass transition temperature (Tg) ranging from −5° C. to 110° C., or a softening point ranging from 33° C. to 140° C. are desirable. More preferably, those with a Tg between 10° C. and 100° C., or with a softening point between 38° C. and 120° C. are used. Still more preferably, Tg should be from 15° C. to 80° C., or the softening point from 38° C. to 100° C.

By using such resins satisfying the conditions for Tg or softening point, the affinity between the surface of the image-receiving layer of the plate and the particulate resin is sufficiently intense, and at the same time, the binding force among the resin particles is large. Therefore, the adhesion between the image and the image-receiving layer and thus the print durability of the plate are enough. With resins having Tg's or softening points outside the preferred range cited above, the affinity between the image-receiving layer and the particulate resin is not enough, or the binding strength among the resin particles is insufficiently weak.

The weight-averaged molecular weight Mw of P should be 1×10³ to 1×10⁶, preferably 5×10³ to 8×10⁵ and more preferably 1×10⁴ to 5×10⁵.

Practical examples for P include olefin polymers and copolymers such as, for example, polyethylene, polypropyrene, polyisobutyrene, ethylene-vinyl acetate copolymers, ethylene-acrylate copolymers, ethylene-methacrylate copolymers, and ethylene-methacrylic acid copolymers, vinyl chloride polymers and copolymers such as poly (vinyl chloride) and vinyl chloride-vinyl acetate copolymers, vinylidene chloride copolymers, polymers and copolymers of vinyl esters of alkanoic acid, polymers and copolymers of allyl esters of alkanoic acid, polymers and copolymers of styrene or styrene derivatives such as, for example, butadiene-styrene copolymers, isoprene-styrene copolymers, styrene-methacrylate copolymers and styrene-acrylate copolymers, acrylonitrile copolymers, methacrylonitrile copolymers, alkyl vinyl ether copolymers, polymers and copolymers of acrylic acid esters, polymers and copolymers of methacrylic acid esters, polymers and copolymers of itaconic acid diesters, maleic acid copolymers, acrylamide copolymers, methacrylamide copolymers, phenol resins, alkyd resins, polycarbonate resins, ketone resins, polyester resins, silicone resins, amide resins, hydroxy and carboxy group-modified polyester resins, butyral resins, poly (vinyl acetal) resins, urethane resins, rosin-based resins, hydrogenated rosin-based resins, petroleum resins, hydrogenated petroleum resins, maleic acid resins, terpene resins, hydrogenated terpene resins, coumarone-indene resins, cyclized rubber-methacrylate copolymers, cyclized rubber-acrylate copolymers, copolymers containing nitrogen-free heterocyclic rings (exemplified by furan, tetrahydrofuran, thiophene, dioxane, dioxofuran, lactone, benzofuran, benzothiophene and 1,3-dioxetane) and epoxy resins.

The content of the resin dispersed in the oil-based ink of the invention should preferably be 0.5 to 20% by weight based on the total ink quantity. Contents below the cited range tend to cause various problems such as a poor wear resistance of recorded images due to a poor affinity of the ink to the plate surface, while, with those exceeding the cited range, homogeneous dispersion becomes difficult, or the ink flow in the ejecting head tends to be non-uniform, hindering a consistent ink ejection.

In addition to the dispersed resin particles described above, the oil-based ink used in the invention can contain a coloring agent that makes visual plate inspection easy after plate making. As preferable examples of such coloring agents, pigments or dyestuffs that have been conventionally used in various ink formulations or liquid toners for electrophotography are included.

Inorganic or organic pigments that have been widely used in graphic arts can be applied to the present purpose, including, for example, carbon black, cadmium red, molybdenum red, chrome yellow, cadmium yellow, titanium yellow, chromium oxide, viridian, cobalt green, ultramarine blue, Prussian blue, cobalt blue, azo pigments, phthalocyanines, quinacrydones, isoindolinones, dioxazines, indanthrenes, perylenes, perynones, thioindigo pigments, quinophthalone pigments, metal complex pigments, and still other ones known in the art.

Suitable dyestuffs include azo dyes, metal complex salt dyes, naphthol dyes, anthraquinone dyes, indigo dyes, carbonium dyes, quinonimine dyes, xanthene dyes, aniline dyes, quinoline dyes, nitro dyes, nitroso dyes, benzoquinone dyes, naphthoquinone dyes, phthalocyanine dyes and metal phthalocyanine dyes.

Each of these pigments and dyestuffs can be used individually or in combination. A preferable range of the content is from 0.01 to 5% by weight of the entire ink quantity.

These coloring agents may be dispersed in the non-aqueous solvent independently from the dispersed particulate resin, or incorporated in the particulate resin. In the latter case, pigments are often coated with resinous materials, and dyestuffs are used to dye the surface of the dispersed particles.

The average particle size of the particulate resin and the particle of coloring agents dispersed in the non-aqueous solvent should preferably be 0.05 to 5 μm, and more preferably 0.1 to 1.0 μm. These particle size values were determined with CAPA-500 manufactured by Horiba Manufacturing Co.

The particulate resin dispersed in the non-aqueous solvent used in the invention can be prepared by conventional mechanical grinding or particle-forming polymerization processes known in the art. As a typical mechanical method, all the ingredients for the particulate resin are mixed, melted and then blended, followed by direct grinding with a grinder; the obtained fine particles together with a polymer dispersant are further dispersed with a wet-type dispersing machine (e.g., ball mill, paint shaker, KD mill or Dyno mill). Another method comprises first preparing a mixture comprising all the ingredients for the particulate resin and an ancillary polymer dispersant (or a polymer for coating), then finely dividing the mixture and finally dispersing the finely divided resin in the presence of a polymer dispersant. Suitable methods include those for the preparation of paint or electrophotographic liquid toner, and detailed descriptions on those are found in, for example, “Paint Flow and Pigment Dispersion”, supervised and translated by Kenji Ueki (Kyoritsu Shuppan Publishers Co., 1971), “Paint Science” by Solomon (Hirokawa Shoten Co., 1969) and “Coating Engineering” (Asakura Shoten, 1971) and “Basic Science of Coating” (Maki Shoten, 1977), both authored by Yuji Harasaki.

As particle-forming polymerization methods, dispersion polymerization in non-aqueous systems is well known. Practical descriptions are found in Chapter 2 of “Recent Technologies of Ultra-fine Polymers”, supervised by Souichi Muroi (CMC Shuppan, 1991), Chapter 3 of “Recent Electrophotographic Developing System and Development of Toner Materials” by Koichi Nakamura (Nihon Kagaku Joho Co., 1985) and “Dispersion Polymerization in Organic Media” by K. E. J. Barrett (John Wiley, 1975).

Usually, in order to stably disperse a particulate resin in a non-aqueous solvent, a polymer dispersant is used. Such a polymer dispersant consists, as its principal component, of a recurring unit that is soluble in the non-aqueous solvent preferably having a weight-averaged molecular weight Mw of from 1×10³ to 1×10⁶, more preferably from 5×10³ to 5×10⁵.

Some preferable examples for such a recurring unit for the polymer dispersant include those expressed by the following general formula (I).

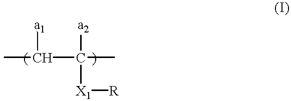

In General formula (I), X₁ represents —COO—, —OCO— or —O—, and R represents an alkyl or alkenyl group of C₁₀₋₃₂, more preferably those of C₁₀₋₂₂ having straight- or branched chain. Though those chains may be substituted or unsubstituted, unsubstituted ones are more preferred.

Practical groups include decyl, dodecyl, tridecyl, tetradecyl, hexadecyl, octadecyl, eicosanyl, docosanyl, decenyl, dodecenyl, tridecenyl, hexadecenyl, octadecenyl and linolenyl.

In General formula (I), a₁, and a₂ may be the same or different, representing a hydrogen or halogen atom such as chlorine or bromine, cyanide, an alkyl group of C₁₋₃ such as methyl, ethyl and propyl, —COO—Z₁, or —CH₂COO—Z₁ wherein Z₁ represents a hydrocarbon group containing carbon atoms not more than 22 such as alkyl, alkenyl, aralkyl, alicyclic and aryl.

The hydrocarbon groups represented by Z₁ include the following: an alkyl group of C₁₋₂₂ that may be substituted, such as methyl, ethyl, propyl, butyl, hexyl, heptyl, octyl, nonyl, decyl, dodecyl, tridecyl, teteradecy, hexadecyl, octadecyl, eicosanyl, docosanyl, 2-chloroethyl, 2-bromoethyl and 3-bromopropyl, an alkenyl group of C₄₋₁₈ that may be substituted, such as 2-methyl-1-propenyl, 2-butenyl, 2-pentenyl, 3-methyl-2-pentenyl, 1-pentenyl, 1-hexenyl, 2-hexenyl, 4-methyl-2-hexenyl, decenyl, dodecenyl, tridecenyl, hexadecenyl, octadecenyl and linolenyl, an aralkyl group of C₇₋₂₂ that may be substituted, such as benzyl, phenethyl, 3-phenylpropyl, naphthylmethyl, 2-naphthylethyl, chlorobenzyl, bromobenzyl, methylbenzyl, ethylbenzyl, methoxybenzyl, dimethylbenzyl, ethylbenzyl, methoxybenzyl, dimethylbenzyl and dimethoxybenzyl, an alicyclic group of C₅₋₈ that may be substituted, such as cyclohexyl, 2-cyclohexylethyl and 2-cyclopentylethyl, and an aromatic group of C₆₋₁₂ that may be substituted, such as phenyl, naphthyl, tolyl, xylyl, propylphenyl, butylphenyl, octylphenyl, dodecylphenyl, methoxyphenyl, ethoxyphenyl, butoxyphenyl, decyloxyphenyl, chloropheyl, dichlorophenyl, bromophenyl, cyanophenyl, acetylphenyl, methoxycarbonylphenyl, ethoxycarbonylphenyl, butoxycarbonylphenyl, acetamidephenyl, propionamidephenyl and dodecyloylamidophenyl.

Suitable polymer dispersants can have other recurring units copolymerized with those represented by General formula (I). Such copolymerization components may consist of any monomer copolymerizable with the monomers corresponding to the recurring unit in General formula (I).

The ratio of the polymer component represented by General formula (I) to the total quantity of the polymer dispersant should preferably be not less than 50% by weight, and more preferably not less than 60% by weight. -Some practical examples of such a polymer dispersant include the dispersion stabilizing resin O⁻¹ used in the following example and commercially available products such as Solprene 1205 of Asahi Chemical Co.

The polymer dispersant should preferably be present in the polymerization system for the resin P defined previously in the case where the resin P is manufactured in the form of latex.

The amount of the polymer dispersant added to the system is from 1 to 50% by weight based on the polymer P.

The particulate resin and the coloring particles (or the particles of a coloring agent) should be in the form of charge-detecting particles with a positive or negative polarity.

To impart a charge-detecting capability to such particles, the technologies used for the preparation of electrophotographic liquid toner are preferably employed. Practical descriptions on charge direction as well as charge directors and suitable additives are found in p. 139-148 of “Recent Electrophotographic Development System and Development of Toner Materials” by Koichi Nakamura cited previously, p. 497-505 of “Fundamentals and Applications of Electrophotographic Technologies”, edited by The Society of Electrophotography of Japan (Corona Co., 1988) and a literature written by Yuji Harasaki in p. 44 of Densi-shashin, 16(2), (1977).

Preferable charge-directors are disclosed in, for example, UK Patent Nos. 893429, 934038 and 1122397, U.S. Pat. Nos. 3,900,412 and 4,606,989, JP-A-60-179751, JP-A-60-185963 and JP-A-2-13965.

The above described charge directors are preferably added to 1000 parts by weight of carrier liquid by from 0.001 to 1.0 parts by weight. Various additives may be incorporated to the ink formulation. The total amount of such additives is limited by the resistance of the oil-based ink: the specific resistance of the liquid phase after the dispersed particles have been removed must be higher than 109 Ωcm, below which good quality continuous tone images can hardly be obtained.

The present invention will be described in greater detail with reference to the following Examples, but the invention should not be construed as being limited thereto.

First, an example of manufacturing a particulate resin for inkjet ink (PL) will be given.

Manufacturing Example 1 for Particulate Resin (PL-1)

A mixture consisting of 10 g of a polymer dispersant (Q-1) having the formula given below, 100 g vinyl acetate and 384 g Isopar H in nitrogen atmosphere was heated to 70° C. under stirring. The mixture was then added with 0.8 g of 2,2′-azo-bis(isovaleronitrile) (A.I.V.N.) as polymerization initiator, and allowed to react for 3 hours. In 20 minutes after the addition of the initiator, the mixture turned turbid and the temperature rose to 88° C. After the addition of 0.5 g of the initiator, the mixture was agitated for 2 hours at 100° C. to remove the remaining vinyl acetate. The reaction product was filtered with a 200-mesh nylon cloth after cooling to give a monodisperse, stable latex of 0.23 μm average particle diameter with a polymerization rate of 90%. The particle diameter was measured with CAPA-500, a product of Horiba Manuf. Co., Ltd.

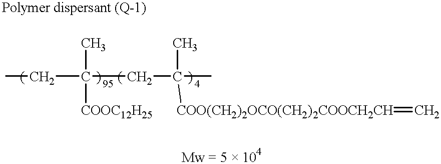

(Copolymerization ratio is expressed by weight ratio.)

Part of the latex was centrifuged at 1×10⁴ r.p.m. for 60 min, and the resulting sediment consisting of the polymer particles was recovered and dried. The weight-averaged molecular weight (Mw: polystyrene equivalent GPC value) of the polymer was 2×10⁵ and its Tg was 38° C.

### EXAMPLE 1

First of all, oil-based ink was prepared. <Preparation of oil-based ink (IK-1)>

A fine dispersion of nigrosine was prepared by rigorously grinding 10 g of a dodecyl methacrylate/acrylic acid copolymer with a copolymerization ratio of 95/5 in terms of weight %, 10 g of nigrosine and 30 g of Shellsol 71 in a paint shaker (a product of Tokyo Seiki Co., Ltd.) together with glass beads for 4 hours. An oil-based black ink was prepared by adding 60 g (as the solid content) of particulate resin Pl-1 described in Manufacturing Example 1, 2.5 g of the nigrosine dispersion prepared above, 15 g of FOC-1400 (tetradecyl alcohol produced by Nissan Chemical Co., Ltd.) and 0.08 g of an octadecene-maleic acid half hexadecylamide copolymer into one liter Isopar G.

Oil-based ink (IK-1) thus prepared was charged by 2 liters in the ink tank of inkjet recording unit 2 in the plate making apparatus (See FIG. 1 and FIG. 3). In this example, a multi-channel type ink ejecting head having 64 channels of 900 dpi shown in FIG. 4 was used. By equipping the ink tank with a throw-in heater and agitating blades as an ink temperature control member, the ink temperature was kept at 30° C. The blades were rotated at 30 rpm and a thermostat was used to keep the temperature constant. This agitating member was also used to prevent sedimentation or aggregation. A transparent window was equipped along the ink flow path through which a set of a LED device and a light detector monitored the ink concentration. Based on signals from the detector, an ink diluent (Isopar G) or an ink concentrate (having a solid concentration twice as much as that of ink IK-1 described above) was added to the ink for concentration control.

A first image-holding body was formed by forming an elastic layer having the following formula on an aluminum drum of 170 mm diameter, 360 mm width and 8 mm thickness.

Styrene-butadiene rubber 100 parts

| | |
|---|---|
| Carbon black | 10 parts |
| Paraffinic oil | 30 parts |
| Vulcanizing agent | 2 parts |
| Vulcanizing aid | 5 parts |

Next, the surface of the elastic layer formed on the drum was sprayed with a coating mixture of the following ingredients.

| | |
|---|---|
| Urethane polymer precursor solution | 80 parts |
| Cross-linking agent solution | 30 parts |
| Teflon powder | 60 parts |
| Dispersing aid | 3 parts |
| Solvent | 60 parts |

The sprayed drum was heated at 100° C. for one hour to give a 95 μm thick surface layer. The resulting product was used as the first image-holding body.

The drum prepared above as the first image-holding body was arranged close to an inkjet recording unit 2 of plate making apparatus 1 (See FIG. 1). Then, the ejecting head was approximated to the drum (the first image-holding body), by sending the signals of the image data to be recorded to the image data processing and control unit, image recording was carried out by ejecting the oil-based ink onto the drum under rotation. In the recording, the end width of the ejecting electrode was set to 10 μm while the spacing between the head and the plate material was adjusted to 1 mm by using an optical gap detector. To a bias voltage of 2.5 kV always applied to the ejecting electrode, a 500 V pulse voltage was superimposed for ink ejection. The duration of the pulse voltage from 0.2 msec to 0.05 msec was divided into 256 steps to control dot areas. During image recording, the surface of the drum was kept roughly at about 35° C.

Then, a 0.12 mm thick aluminum plate that has been subjected to graining and anodic oxidation, as a second image-holding body, was brought into contact with the drum surface by means of a heat roller kept at 80° C. with a contact pressure of 0.3 Mpa. By this operation, the image formed on the drum was transferred to the aluminum plate. The image transfer was perfect, leaving no ink on the drum at all.

Then, a xenon flash fixing device (a product of Ushio Denki Co., having an emission intensity of 200 J/pulse) was used to heat and enforce the image, thus giving a plate for printing. The finished plate was loaded on the plate cylinder of an Oliver 266EPZ press machine and lithographic printing was performed. The plate gave rise to more than 20,000 high image quality prints.

Such image transfer from the drum as the first image-holding body to the aluminum plate as the second image-holding body was repeated ten thousand times. The transfer characteristics did not change at all keeping the initial ones, and the plates yielded sharp and crisp prints free of void or blur. Moreover, instead of aluminum plate, the following various plate materials were used to receive images, resulting in a perfect image transfer. ELP Master, which is a commercially available ZnO-based plates made by Fuji Photo Film Co., Ltd., Straight Master (a product of Mitsubishi Paper Mill Ltd.), a paper master that receives images formed by usual PPC copiers and printers, and Kimoplate made by Kimoto Co., Ltd., Omega E-Z made by Autotype International Co., Ltd. and Miliad-2 made by Agfa-Gevaert Co., Ltd., each being film masters for direct drawing. Each printing plate had a run length of several thousand or more.

After plate making, the ejecting head was washed for 10 min with Isopar G, which was removed from the head aperture. Then, the head was kept in a closed space filled with the vapor of Isopar G. By such an operation, the head operated perfectly for 3 months without any additional maintenance, consistently making high quality plates for printing.

According to the invention, printing plates can be made that can produce a large number of sharp and crisp prints. Further, high quality printing plates corresponding to digital image data can be directly obtained consistently, thus enabling an economical and high-speed lithographic printing.

While the invention has been described in detail and with reference to specific examples thereof, it will be apparent to one skilled in the art that various changes and modifications can be made therein without departing from the spirit and scope thereof.

What is claimed is:

1. A method of making a printing plate comprising
forming an image on a surface of a first image-holding body based on image data signals by an electrostatic inkjet process comprising ejecting an oil-based ink; and
contact-transferring the image formed on said first image-holding body onto a second image-holding body.

2. The method according to claim 1, wherein said oil-based ink comprises:
a non-aqueous solvent having a specific resistance not lower than 10⁹ Ωcm and a dielectric constant not higher than 3.5; and
a hydrophobic particulate resin dispersed in said solvent, the resin being solid at least at room temperature.

3. The method according to claim 1, further comprising setting a surface temperature of said first image-holding body to in the range of from 30 to 40° C. during said image formation.

4. The method according to claim 1, further comprising fixing the image transferred on said second image-holding body.

5. A plate making apparatus comprising:
an inkjet image recording unit which forms an image based on image data signals on a first image-holding body by ejecting an oil-based ink from an ink ejecting head using an electrostatic field; and
an image transfer member which transfers the image formed on said first image-holding body onto a second image-holding body by contact transfer.

6. The plate making apparatus according to claim 5, wherein said oil-based ink comprises:
a non-aqueous solvent having a specific resistance not lower than 10⁹ Ωcm and a dielectric constant not higher than 3.5; and
a hydrophobic particulate resin dispersed in said solvent, the resin being solid at least at room temperature.

7. The plate making apparatus according to claim 5, wherein said first image-holding body is a rotary member comprising a drum or an endless belt.

8. The plate making apparatus according to claim 5, wherein said first image-holding body is elastic.

9. The plate making apparatus according to claim 5, further comprising a temperature control member which acts to set a surface temperature of said first image-holding body in the range from 30 to 40° C. upon said ejecting.

10. The plate making apparatus according to claim 5, further comprising a cleaning member which cleans said first image-holding body.

11. The plate making apparatus according to claim 5, further comprising an image fixing member which fixes the image transferred onto said second image-holding body.

12. The plate making apparatus according to claim 11, wherein said image fixing member includes a heating member comprising at lease one of a heat roller and a lamp selected from IR, halogen and xenon lamps.

13. The plate making apparatus according to claim 12, wherein said heating member is arranged and/or regulated so as to gradually elevate a temperature of said second image-holding body at said image fixing.

14. The plate making apparatus according to claim 7, wherein said rotary first image-holding body is rotatable to carry out main scanning upon said image recording onto said first image-holding body.

15. The plate making apparatus according to claim 14, wherein said ink ejecting head comprises a single-channel or multi-channel head movable in a direction parallel to an axis of said rotary first image-holding body to carry out sub-scanning upon said image recording.

16. The plate making apparatus according to claim 14, wherein said ink ejecting head comprises a full-line head having a width substantially equal to that of said first image-holding body.

17. The plate making apparatus according to claim 5, wherein said inkjet recording unit has an ink feeding member which feeds said oil-based ink to said ink ejecting head.

18. The plate making apparatus according to claim 17, wherein said inkjet recording unit has an ink recovering member which recovers said oil-based ink from said ejecting head to circulate said ink.

19. The plate making apparatus according to claim 5, wherein said inkjet recording unit has an ink tank and an agitating member which agitates the oil-based ink in said ink tank.

20. The plate making apparatus according to claim 5, wherein said inkjet recording unit has an ink temperature control member which controls a temperature of the oil-based ink at least one of inside an ink tank and inside an ink flowing path.

21. The plate making apparatus according to claim 5, wherein said inkjet recording unit has an ink concentration control member.

22. The plate making apparatus according to claim 5, further comprising a cleaning member for said ink ejecting head.
